(19) United States
(12) Patent Application Publication
(10) Pub. No.: US 2014/0331804 A1
(43) Pub. Date: Nov. 13, 2014

(54) ACTUATING DEVICE HAVING KEYS

(71) Applicant: ZF Friedrichshafen AG, Friedrichshafen (DE)

(72) Inventors: Ralf Pfeifer, Diepholz (DE); Andreas Giefer, Lemfoerde (DE)

(21) Appl. No.: 14/357,146

(22) PCT Filed: Oct. 19, 2012
(86) PCT No.: PCT/EP2012/070709

§ 371 Date: May 8, 2014

(30) Foreign Application Priority Data
Nov. 21, 2011 (DE) 10 2011 086739.2

(51) Int. Cl. F16H 59/02

(52) U.S. Cl. CPC F16H 59/02
USPC 74/473.3

(57) ABSTRACT

This invention relates to a system for selecting switching steps of a shift-by-wire gear change drive, which features a key arrangement with at least two keys and means for generating electrical signals for transmission to the shift-by-wire gear change drive. This invention specifies an activation control system with which can prevent errors and can lift out a key from a lowered position. The activation control system also features a pressure pad located below the keys.

This invention relates to a system for activating a technical system with a key arrangement according to the overhand grip of claim 1. For example, such activation control systems are used for manually selecting switching steps or gear pre-selection in case of gear change drives of vehicles, although not exclusively so. The operating status of a vehicle drive may be changed using electrical or electronic signal transmission with a corresponding activation control system. Such a form, without mechanical connection, managing with electrical or electronic control of technical systems or drives however implies that the operator or driver generally gets no immediate feedback about the execution of his control order and even a possibly missing feasibility thereof, in contrast to the operation using the known mechanical activation control systems.

In activation control systems with keys using electrical or electronic signal transmission, it is however more likely that the controlling system or vehicle drive does not engage the operating state associated with the pressed key, after pressing one of the keys of the activation control system, due to certain reasons. In other words, this means that the target state of the controlled system, e.g., the vehicle drive, selected using the keystroke, does not correspond with the actual switch state of the system or drive. Such divergence between the actual operating state of a technical system and the supposed control command entered at the control keys may have different causes.

In the example, the control or gear pre-selection at an automatic vehicle operation are provided with a vehicle equipped with automatic drive, usually with a so-called shift-lock function. In case of a vehicle with a shift-lock function, the key positions “D” and “R” can in particular only be selected from the neutral position “N” if the foot brake is simultaneously depressed. This serves to ensure safety and is supposed to prevent that a drive position is engaged and that the vehicle is put in motion without control, with a running engine, e.g., due to inadvertently pressing the drive selection lever.

In case of electrical or electronic key control of a shift-by-wire vehicle drive equipped with a shift-lock function, the driver can however select the switch position “D”, for example, by pressing the corresponding keys in case the foot brake is depressed. Since the foot brake is however not depressed in the example, the drive remains unchanged in the neutral position “N” due to the shift-lock function, whereas the driver believes that the corresponding drive position is now engaged after pressing the key “D”. As a result, this situation leads to a potential safety risk, since the vehicle at a slope may inadvertently roll backwards in such a case, for example, or the driver may not be able to get out of a dangerous situation quickly enough in the false belief that the forward drive has been engaged.

Moreover, even an erroneous or non-functional transfer of the control commands between the activation control system and the system or vehicle drive controlled by it may be present, for example. This may result in the pre-selected drive speed not being recognized by the system and thus the corresponding control command not being given to the drive.

The problem that simultaneously pressing sometimes different keys of the activation control system is sometimes undesirable also arises. For example, such an activation may occur by human error or incorrect activation, by children, who are playing, for example. Today, the option does essentially exist to recognize switching several keys by logic stored for the activation control system and giving feedback to the operator. But even a corresponding software solution cannot always prevent resultant failures in case of such multiple activations of keys, and the vehicle remains stationary, if this is the case. Sticky keys, which can be caused by spilling drinks containing sugar, for example, further justify the danger of multiple switching, which goes unremarked by the operator. In this case, the individual keys of the respective return elements are usually insufficient to restore the reset elements, in particular spring elements, to their raised position. To the extent the user recognizes such a state, he/she will try to raise the key with tools, which could lead to damaging the key, without mentioning delays in the operating procedure.

E.g., an activation control system with the characteristic features is known from DE 10 2004 054 617 B3, which contains other proof about the relevant state-of-the-art technology.

The task of this invention is to indicate a system for electrical or electronic activation of a technical system controlled by keys, e.g., a gear change drive, with which the aforementioned disadvantages of state-of-the-art technology can be overcome. In particular, this invention attempts to specify an activation control system, which prevents several switches from being activated simultaneously, which is not allowed.

In order to solve the above task, an activation control system with the characteristics of claim 1 is specified with this invention. Recommended further training programs are specified in the sub-claims.

The system according to the invention involves a key arrangement with at least two keys in a known way. Moreover, the activation control system features the generation of electrical control signals for the transfer of a switch command to the controlling technical system. It is self-explanatory that the individual keys can be assigned to reset elements, in particular reset springs. Furthermore, the keys are usually assigned to contacts, which are brought into contact by activating the keys. The activation control system according to the invention also includes mechanical conductors for conducting movements when lowering or raising the key and regular elastic seals to protect the internal area of the activation control system against becoming dirty and the infiltration of humidity from outside.

The activation control system according to the invention is characterized by the keys being underpinned with pressure pads. Thus, only one pressure pad is usually assigned to several keys. The pressure pad is thus dimensioned in such a way that upon pressing a key, it is lowered and sent to the pressure pad such that the pressure pad interacts with the other key(s), which are not lowered in such a way that they are held in their raised position, and lowering them is not possible. Accordingly, the pressure pad also preferably prevents lowering the pressure pad of another key with an already lowered key. Furthermore, a key that is jammed or stuck in the, lowered position can for example be brought back again to the raised position easily by lowering another, preferably immediately neighboring key. Thus, the pressure pad is usually dimensioned in such a way that the pressure pad applies against the other or the remaining key(s) when it is lowered, in order to prevent multiple switching of keys, i.e., to secure and/or bring the other keys into the raised position.

For this purpose, a housing is preferably provided, which incorporates the pressure pad in such a way that a displacement of the pressure pad's volume can primarily take place, preferably only in the direction of the keys. Accordingly, pressing in the pressure pad leads to a movement of the pressure pad only in the direction of the other keys by lowering only one key. As long as “the other keys” are subsequently applied, this description with regard to the unusual case occurs, in which the activation control system has more than two keys, even if one such activation control system provided with only two keys is supposed to be included by the protection of the patent sought. The aforesaid house for exact fit of the pressure pad usually also forms the conductors for moving the keys and is used for the structural integrity of the activation control system.

It is advantageous if the pressure pads provide a gel pad. This gel pad usually involves a pad filled with gel. The gel is contained in a cover therewith. This cover can be an elastic or inelastic cover, like the cover of every pad of this invention.

Gel is to be favored since it is incompressible and moreover features high viscosity, so that the pressure pad executes a steady, regular movement upon activating a key, and moreover the contents of the pad are hardly influenced by a certain rigidity achieved by the viscosity, however they are to a negligible extent due to accelerations, e.g., upon operating the vehicle.

A finely dispersed system made of at least one solid and one liquid phase is to be understood as gel in this regard. The solid phase here forms a spongy, three-dimensional network, whose pores are filled up by a liquid (iyogel) or even a gas (xerogel). Aerogel, whose network is highly porous, and which is stored in air as gas, may also be used here.

According to a preferred arrangement, the pressure pad features a magnetorheological fluid or a ferrofluid. This fluid may be the fluid in the gel. These fluids have the advantage that it can be aligned magnetically in order to signal feedback to the driver via the key, for example. Thus, a low-frequency AC voltage can be supplied, for example, to get the pressure pad and thus the key touching the pressure pad to vibrate, which can be perceived via the user's limbs.

More preferably, the activation control system includes a magnetic field generation device for generating a magnetic field, which can be created, controlled via the fluid for controlled impact of the fluid's viscosity. The fluid can thereby be so influenced in a controlled manner that a desired behavior of the fluid can be generated as previously described in the example. Alternatively, the activation control system can be designed to interact in such a manner with such a magnetic field generation device that the fluid's viscosity can be influenced using a magnetic field, which can be created by the magnetic field generation device and controlled by it. The magnetic field generation device can be preferably assigned to the technical system in this regard. Control of the magnetic field generation device or the magnetic field, which can be created, controlled can preferably take place via an activation control system, in particular via the means for generating electrical control signals or the magnetic field control assigned to the technical system. The magnetic field control can preferably be suited to control the magnetic field, which can be created and controlled by the magnetic field while considering the means for generating electrical control signals for transfer as required to the electrical control signals transferred to the technical system as mentioned previously or described in detail below.

Even if it is possible to design the pressure pad with a certain play so that a certain mobility of the keys is possible even in case of an inserted key, however the insertion leads to lifting another, previously lowered key out, it is to be preferred to measure the pressure pad in such a way that in case of depressed position of one of the keys, this lowered key prevents the other keys from being lowered in the depressed position via the pressure pad. In other words, the pressure pad does not only lie immediately on the other keys in case a key is lowered. In this regard, the pressure pad is rather additionally so dimensioned and designed and included in the housing, which lowering another key is not possible in any way. In fact, only one key can be lowered, whereas the other keys are securely fixed in the raised position by the pressure pad in the preferred design.

The previously described additional modification usually entails that all keys touch the pressure pad in every position of the keys. The keys are accordingly permanently coupled via the pressure pad in every operating state, in particular in such a way that lowering an individual key immediately leads to the lifting out of another key that was previously lowered.

This preferred additional modification can be brought about by adjoining the pressure pad under preload to the keys. Accordingly, a volumetric dimensioning does not lead to the pressure pad adjoining the keys in every position. Rather, a compensation volume is created by the preload, so that the activation control system can be economically produced, and moreover a certain pressure buffer is realized that ensures that the pressure pad abuts all keys in every position of the keys at all times. The spring preload can be realized in this regard by a conventional spring element, i.e., mechanical spring element. Alternatively, or additionally, the spring preload can also be developed by a volume of a compressed fluid enclosed in the housing acting on or in the pressure pad.

The pad's adjoining the keys under preload in any case prevents a return stroke. All keys can also be secured in the raised position, and only lowering a single key leads to further raising the preload by compression of the element or medium exercising the preload. In this regard, the medium or agent exercising the preload is preferably selected in such a manner that only a single key can be lowered while the other keys are secured in the raised position, and are not allowed to be lowered even by further compression of the medium or agent exercising the preload.

Continuing education has the advantage that the preload, and thus the key's resistance against being lowered can be set easily. Compensation for any volume changes due to the temperature of the pressure pad is also provided by the agent or medium causing the preload, so that the device works without error even with highly fluctuating external and/or operating temperatures.

To the extent the preload is exercised in this regard by an enclosed volume of a compressible fluid, this should preferably be selected as gas in such a way that at the lowest operating temperature, e.g., −40° C., the gas is already vaporized and generates an internal pressure. The fluid should moreover be chosen such that the gaseous part doesn't yet behave like an ideal gas and instead shows a reduced rise in pressure with increasing temperature. The fluid used preferably lowers the temperature influence on the internal pressure by this behavior, and accordingly homogenizes the operating comfort of the activation control device according to the invention while changing operating or working temperatures. With a view on the usual working temperatures of vehicles, the fluid should have a reduced rise in pressure with increasing temperatures in a temperature interval of about −40° C. to +40° C., preferably up to 85° C.

With a view to manufacturing as cheaply as possible, according to preferable continuing education of this invention, it is recommended to develop the pressure pad by a rubber hose surrounding a pad stuffing. In this regard, this may in particular involve a rubber hose manufactured according to the form-fill-seal procedure, which has two cross welding seams and one longitudinal one extending between them, where the latter forms the unending film material of the plastic material fed as sheeting into a hose, which is formed into a pad respectively closed at the ends.

The cladding material surrounding the pad should thus be adjusted in such a manner on the parts of the activation control system surrounding the pad, in particular the surface of the keys adjacent to the pad, since either there is a low coefficient of friction between the cladding of the pad and the areas concurrent to it, or values that are as similar as possible for the coefficient of static and/or kinetic friction. Due to this, self-generated slip-stick friction, also described as slip-stick effects, is prevented as far as possible. Alternatively, or additionally, dry lubrication may also be provided with graphite or silicone, for example, between the friction surfaces. In view of the fact that the tangential stress is twice as high as the axial stress (pipe formula) in an elongated body under internal pressure, the film material forming the cladding may have an anisotropic structure. Thus, the film in the tangential direction may be reinforced by fibers in the tangential direction.

As already mentioned, the cladding itself may be inelastic or elastic. The fluid should be selected such that it is planned to be in a gaseous state, preferably however in a liquid state, even in a temperature range of −40° C. to 85° C. The fluid should naturally be selected in such a manner that no dangers for the health of the users or the environment result from it. The fluid should moreover be selected such that it does not behave aggressively, and is harmless with respect to electronic components, so that any leakage of the fluids does not affect the electrical and electronic signal components of the control system, so that it needs to be replaced only in case of a defective pressure pad. The fluid can be prepared as a mixtures of different liquids, e.g., of hydrocarbons. In case of a gel pad, it is advantageous to also mix gaseous parts to it. The gaseous parts may cause a preload in the gel for itself by compression. The gaseous parts should also be selected such that a broader boiling range results. A mixture of water and monethylene glycol, which is usually used as the main component in coolants is also considered as a fluid in the pressure pad.

When selecting the fluid, it can be selected such that it is non-Newtonian, but in fact changes its viscosity depending on the shear rate, in order to also influence the haptic properties. The fluid may behave in a thixotropic or rheopex manner. A shear thickening fluid is to be especially preferred. As already mentioned previously, a magnetorheological fluid or a ferrofluid or a magnetorheological elastomer allows influencing the properties of the fluid externally by an electrical or magnetic field. This cannot show an operating state only by vibration. Rather, the activation control system can also include agents such as the aforementioned magnetic field generation device and/or the magnetic field control, which have influence on the viscosity of the selected fluid. Thus, the control can be provided, for example, which compensates original viscosity changes caused by temperature by creating a magnetic field. At higher temperatures, the magnetorheological fluid is accordingly made relatively more viscous, for example, with the aim to achieve as constant a rheological behavior as possible over the conceivable temperature range of the working temperature, and thus operating comfort with constant quality of the activation control system. The control device may alternatively or additionally also be connected with logic, which displays a certain operating state or behavior of the activation control system notified via the keys to the user about the stimulation of the fluid. Thus, for example, an operating state in which no further activation of the keys is supposed to be possible any more, should be displayed by the fact that a higher resistance to movement is printed to the fluid about the magnetic properties of the fluid. To the extent that the underlying logic wants to signal to the user that the command notified by the keys by activating the keys is not executed, a vibration of the pad can be caused by the selected fluid, for example, which signals to the driver that the command is ignored.

Other details and advantages of this invention result from the following description in connection with the drawing. This drawing represents the following:

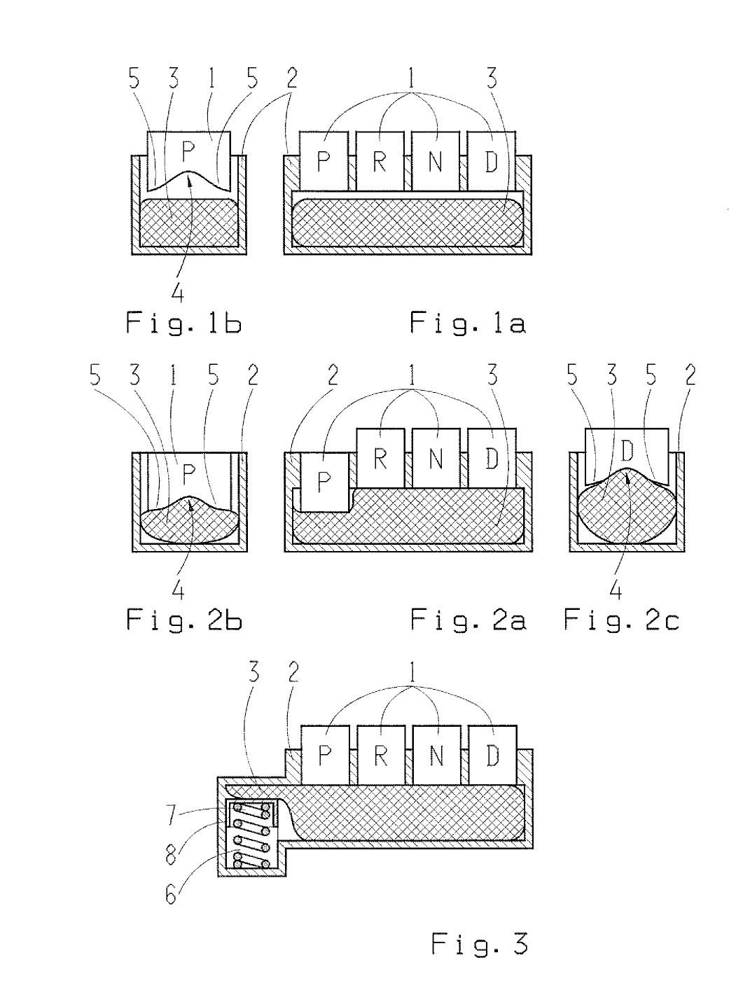

FIG. 1a a longitudinal view of a first execution example with raised keys;

FIG. 1b the operating state shown in FIG. 1a for the first execution example in a schematic cross-section view;

FIG. 2a the execution example shown in FIG. 1a, 1b with a lowered key;

FIG. 2b the representation according to FIG. 1b for the lowered key as per FIG. 2a;

FIG. 2c the representation according to FIG. 1b for a key that is not lowered as per FIG. 2a;

FIG. 3 a longitudinal view of a second execution example;

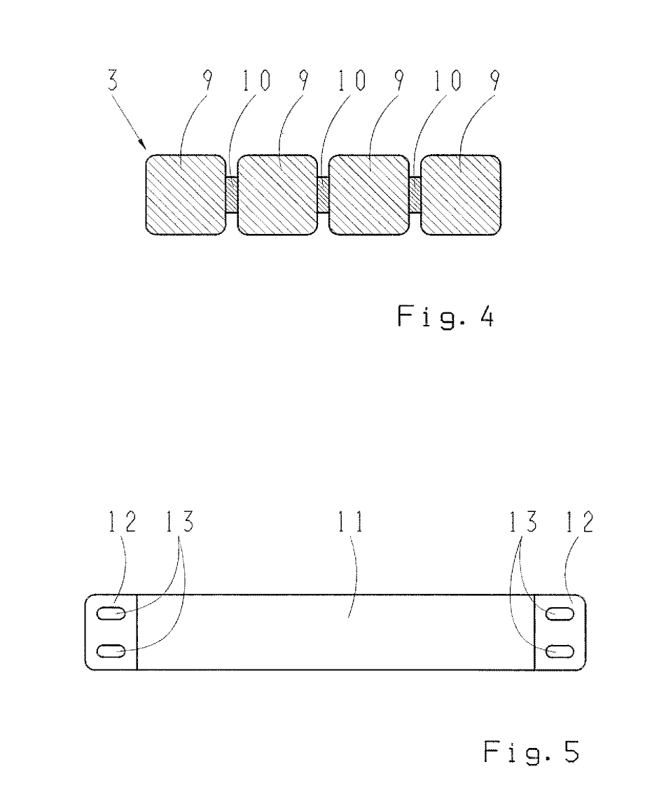

FIG. 4 a plan view of another execution example of a pressure pad; and

FIG. 5 a plan view of a third execution example of a pressure pad.

FIG. 1a and 1b illustrate a first execution example of an activation control system with Keys 1, which are movably arranged in Housing 2. Conductors and switch contacts, which convert the different positions of Keys 1 into electrical or electronic signals, are not represented in the schematic diagram. A Pressure Pad 3 is included in Housing 2. This Pressure Pad 3 is placed full-faced and adjacent to the inner walls of Housing 2 in the operating state shown in FIG. 1a, 1b in which all Keys 1 are arranged in the raised position. Only the designed upper side of Pressure Pad 3 neighboring Keys 1 is exposed in Housing 2. In fact, there is acertain clearance between the lower side of Keys 1 and the upper side of Pressure Pad 3.

Keys 1 have a lower side that interacts with Pressure Pad 3, which shows a gently curving contour. Keys 1 are provided with a centrally formed Notch 4 in the cross-section representation (see FIG. 1b). Accordingly, the wing-shaped protrusion 5 limiting Notch 4 in the transverse direction first acts on Pressure Pad 3 upon lowering a Key 1, so that the volume of Pressure Pad 3 arches upward and is primarily brought into Notch 4 (see FIG. 2b). As a result, Pressure Pad 3 moves with the other Key 1, which is not lowered (see FIG. 2c). After complete lowering of Key 1 primarily assigned to the operating state Parking P, Pressure Pad 3 is adjacent on the lower side to the other Keys 1 assigned to the operating state Reverse Drive R, the operating state Neutral D and the operating state Forward Drive D, and fixes them in the raised setting (see FIG. 2a, 2c).

FIG. 3 illustrates another execution example, which is essentially developed like the previously described execution example. Same components are provided same reference signs. The execution example as per FIG. 3 additionally has a Spring Device 6, which holds the pressure pad under preload in the exit position shown in FIG. 3, in which all Keys 1 are fixed in the raised position, as opposed to the previously described execution example. Spring Device 6 is primarily designed as a spring device with a mechanical Spring Element 7 in the form of a coil spring, which acts against Pressure Pad 3 under the intermediate layer of an End Cap 8. Accordingly, all Keys 1 are secured in the raised position via the preload of Spring Device 6 in the exit position shown in FIG. 3. If a Key 1 is now lowered, the volume of the Pressure Pad 3 underlying Key 1 is forced out from an area below Key 1 in the direction of Spring Device 6. This leads to Spring Device 6 being compressed. Spring Device 6 is dimensioned in such a way herewith that its maximum compression is achieved when one Key 1 has reached its lowered position. This can be done by appropriately designing a cylindrical collar of End Cap 8. The maximum compression of Spring Device 6 is reached when this cylindrical collar hammers on the bottom of Housing 2. Accordingly, the other Keys 1 are prevented from being able to be lowered in the lowered position of a Key 1.

FIG. 4 illustrates an execution example of a Pressure Pad 3, which primarily develops Chambers 9, one assigned to each key, which are connected to each other by overflow channels. Pressure Pad 3 as per the execution example according to FIG. 4 accordingly illustrates a continuum, where individual Chambers 9 are dimensioned such that they underlie the entire area of a Key 1. For this purpose, Housing 2 can respectively develop Chambers 9 into narrow surrounding receiving chambers, which are only connected to each other via a tunnel receiving Overflow Channel 10 in each case, which prevents Pressure Pad 3 in the range of Overflow Channel 10 from expanding radially. It is ensured in this way that the volume of Pressure Pad 3 can only be changed between Chambers 9, however Overflow Channels 10 are maintained at constant volume. This Overflow Channel 10 is particularly well suited to influence magnetorheological fluids or ferrofluids by a magnetic field.

FIG. 5 finally shows a schematic plan view on a third execution example of a pressure pad in the form of a Gel Pad 11, whose floor forms bordering Clips 12 with Fastening Eyes 13 for mounting the Gel Pad 11.

### REFERENCE NUMBERS

1 Keys
2 Housing
3 Pressure pad
4 Indentation
5 Projections
6 Spring device
7 Spring element
8 End cap
9 Chamber
10 Transfer port
11 Gel pad
12 Clips
13 Fastening eyelets

1. An activation control system for selecting switching steps of a shift-by-wire gear change drive, the activation control system comprising:
a key arrangement comprising two keys wherein each key is operable to transition between a raised position and a depressed position; and
a pressure pad configured to generate electrical signals for transmission to the shift-by-wire gear change drive, wherein the pressure pad is located under the key arrangement and contacts the keys of the key arrangement.

2. The activation control system of claim 1, wherein the pressure pad is a gel pad.

3. The activation control system of claim 1 wherein the pressure pad comprises a fluid with a viscosity that can be changed by applying a magnetic field.

4. The activation control system of claim 3 comprising a magnetic field generation device configured to generate and control the magnetic field.

5. The activation control system of claim 1 wherein the pressure pad is dimensioned so that when one of the keys of the key arrangement is in the depressed position, the pressure pad prevents the other key(s) of the key arrangement from being lowered to the depressed position.

6. The activation control system of claim 1 wherein the pressure pad is dimensioned so that for each position of each key, all keys contact the pressure pad.

7. The activation control system of claim 1, wherein the pressure pad (3) is configured to contact the keys under a preload.

8. The activation control system of claim 7, wherein a spring element is configured to exert the preload.

9. The activation control system of claim 7, wherein an enclosed volume of a compressible fluid is configured to exert the preload.

10. The activation control system according to claim 1, wherein the pressure pad comprises a rubber hose surrounding a pad stuffing.

11. The activation control system according to claim 1, wherein the pressure pad forms a chamber corresponding to each key, and wherein the chambers connect to each other via an overflow channels.

12. The activation control system of claim 3, wherein the fluid is a magnetorheological fluid.

13. The activation control system of claim 3, wherein the fluid is a ferrofluid.

14. The activation control system of claim 1, wherein when one of the keys is moved to the depressed position, the other keys of the key arrangement are returned to the raised position.

15. The activation control system of claim 7, wherein the preload is adjustable to compensate for volume changes to the fluid at different temperatures.

16. The activation control system of claim 8, wherein the spring element is a coil spring.

17. The activation control system of claim 8, wherein when one of the keys is in the depressed position, the spring element is maximally compressed.

18. The activation control system of claim 8, wherein the spring element comprises a coil spring surrounded by a spring collar, and when one of the keys is in the depressed position, the spring collar prevents the spring element from being further compressed.
